(19) United States
(12) Patent Application Publication
(10) Pub. No.: US 2019/0364036 A1
(43) Pub. Date: Nov. 28, 2019

(54) SYSTEMS, APPARATUS, AND METHODS FOR LOW-POWER, INTERMITTENTLY-CONNECTED, SECURITY DEVICES AND OTHER DEVICES

(71) Applicant: Simtek, Inc., Mountain View, CA (US)

(72) Inventors: William Brady Simpson, Mountain View, CA (US); Ari Chivukula, Seattle, WA (US); Norman Scott Storkel, Mountain View, CA (US); Steven Shenker, Cape Town (ZA); Eric Shrewsberry, Palo Alto, CA (US); Phang Moh Lim, Setia Alam (MY); John O'Leary, Golden, CO (US)

(73) Assignee: Simtek, Inc., Mountain View, CA (US)

(21) Appl. No.: 16/419,186

(22) Filed: May 22, 2019

Related U.S. Application Data
(60) Provisional application No. 62/676,249, filed on May 24, 2018.

(51) Int. Cl. H04L 29/06; H04L 29/08; H04W 4/60; H04W 12/00; G06K 7/14

(52) U.S. Cl. CPC H04L 63/0853; H04L 67/104; H04W 4/60; G06K 7/1408; H04W 12/00522; H04L 63/18; H04L 63/10

(57) ABSTRACT

The present disclosure generally relates systems, apparatus, and methods for security devices, in particular, low-power, security devices and other devices. The devices typically connect to the Internet or other networks only on an intermittent, event-based basis, typically by cellular modem. The invention meets a need for security devices, as well as other devices, that can connect to the Internet and other networks but that are low-power and/or intermittently connected to networks such as the Internet on an intermittent and/or on demand basis. This renders them more secure, less susceptible to hacking and other attacks, less prone to continuously gathering data that a user might consider to be superfluous and/or invasive in terms of data collected, and can make them low-power, thus allowing them to run on battery for long periods of time.

### APPLICATION PRIORITY DATA

This application claims the benefit of U.S. Provisional Patent Application No. 62/676,249, filed May 24, 2018, first inventor Simpson, which is/are all hereby incorporated by reference in their entirety.

### FIELD OF THE INVENTION

The present disclosure generally relates systems, apparatus, and methods for devices, in particular, low-power, security devices and other devices. The devices typically connect to the Internet or other networks only on an intermittent, event-based basis, typically by cellular modem.

### BACKGROUND OF THE INVENTION

Network-connected security and Internet-of-Things (IoT) devices are increasingly in demand and prevalent as services and objects. Such devices monitor homes and spaces, for instance, by collecting information such as video and temperature, and managing them, for instance, by changing thermostat settings or watering plants. However such devices are generally relatively insecure devices that are constantly connected to the Internet via Wi-Fi or other means, and consume significant power by always being powered up, meaning they cannot run for long periods on battery.

Therefore there is a need for security devices, as well as other devices, that can connect to the Internet and other networks but that are low-power and/or intermittently connected to networks such as the Internet on an intermittent and/or on demand basis. This renders them more secure, less susceptible to hacking and other attacks, less prone to continuously gather data that a user might consider to be superfluous and/or invasive in terms of data collected, and can make them low-power, thus allowing them to run on battery for long periods of time.

### SUMMARY OF THE INVENTION

The present disclosure includes systems, apparatus, methods, and means concerning security devices other devices. These include pairing a device with a smartphone via a server, including receiving data relating to a first unique identifier scanned by a user, or a second unique identifier manually entered by a user, with the smartphone, and using the data to pair the smartphone to the device via the server, wherein the invention does not require either the smartphone or the server to communicate with the device.

The invention also includes systems, apparatus, methods, and means for pairing a device with a cell phone via a server, including receiving data relating to a unique identifier manually entered by a user using a cell phone and using the data to pair the smartphone to the device via a server. The invention also includes wherein the first unique identifier is a QR code that identifies the device, a unique identifier that is a MAC ID address that identifies the device, wherein the device has no local connection capability, including Bluetooth and Wi-Fi, wherein the server is a cloud server(s) or stand alone server(s), wherein the data is received by an app on the smartphone and received by the server from the app via the Internet, wherein the device has a cellular modem for connecting to the Internet, wherein the device has means for identifying an event, wherein the device has one or more of the following: a motion detector, electromagnetic radiation detector, sound detector.

The invention also includes systems, apparatus, methods, and means for a device firmware, wherein the device has memory comprising four partitions, a first partition which has a boot loader firmware, a second partition which has an application firmware, a third partition which has a second copy of the application firmware, and a fourth partition which has a rescue firmware, the method comprising, including a method for restart of the device, downloading a firmware update into second partition, running the firmware update, and in an event of failure of the firmware update, running the rescue firmware.

The invention also includes systems, apparatus, methods, and means for a device including means for detecting electromagnetic radiation, physical motion, or both, and means for transiently connecting, based on an event, to a network such as the Internet, a method of providing low power, physical security to a space, including, awaiting detection of an event, connecting to a network, communicating data on the event to a server, recording the data, communicating details on the event to a client.

The invention also includes computer methods, software and computer program products for all of the above and below as disclosed.

### BRIEF DESCRIPTION OF THE DRAWINGS

A preferred embodiment of the device is illustrated in FIG. 1 and FIG. 2. FIG. 1 is a top front view and FIG. 2 is a top rear view. Not all of the elements of the device are illustrated.

FIG. 3 is a flowchart that describes the initial device pairing.

FIG. 4 is a hardware block diagram of a related preferred embodiment of the device and invention.

FIG. 5 is a table listing the hardware of the device and invention, compatible with the above preferred embodiment of FIG. 4.

FIG. 6 is a flowchart that describes event detection, firmware update, and relates steps.

FIG. 7 is a block diagram of an exemplary computing system that may be utilized to practice aspects of the present disclosure.

The described techniques and mechanisms, together with other features, embodiments, and advantages of the present disclosure, may best be understood by reference to the following description, taken in conjunction with the accompanying drawings, which illustrate various embodiments of the present techniques and mechanisms.

In the patent application, figures, and possibly tables and other illustrative materials are featured throughout the specification.

### DETAILED DESCRIPTION OF THE INVENTION

Definitions

The following definitions, among others, are generally known in the art and are understood by one of ordinary skill in the art.

“Short Message Service” (SMS) is a text messaging service component of most wireless cellular telephone, the World Wide Web, and mobile devices systems. It uses standardized communication protocols to enable mobile devices to exchange short text messages. Messages are typically up to 160 characters in length, though some services use 5-bit mode, which supports 224 characters. SMS was originally created for phones that use Global System for Mobile (GSM) communication, but now all major cellular telephone systems support it.

“Global System for Mobile” (GSM) is a widely used digital mobile telephony system, originally developed in Europe, GSM uses a variation of time division multiple access. GSM digitizes and compresses data, then sends it down a channel with two other streams of user data, each in its own time slot. It operates at either the 900 MHz or 1800 MHz frequency band.

Note that many other telephony technologies are contemplated, including TDMA and CDMA, which are also compatible with the current invention. Time division multiple access (TDMA) is a technology that divides each cellular channel into three time slots in order to increase the amount of data that can be carried. Code-Division Multiple Access CDMA refers to any of several protocols used in second-generation (2G) and third-generation (3G) wireless communications. CDMA is a form of multiplexing, which allows numerous signals to occupy a single transmission channel, optimizing the use of available bandwidth.

“General Packet Radio Services” (GPRS) is a packet-based wireless communication service for wireless cellular telephone networks. GPRS is based on GSM communication and complements existing services such circuit-switched cellular phone connections and the Short Message Service (SMS). GPRS has certain generational standards such as 2G and 3G. The current invention is compatible with both of these generations and likely future generations.

“Cellular modem” is a wireless modems that allow computers, phones, and other devices for Internet access. Instead of connecting to a cable that serves as the network pipe, cellular modems communicate over wireless networks to the Internet via cellular (cell) phone towers. A cellular modem typically has one or more antennas, sometimes embedded on a circuit board and sometimes a separate antenna that may be entirely inside the device or that may protrude from the device. Antennas are typically engineered for particular communication protocols, such as Universal Mobile Telecommunications Service (UMTS) GSM, a third-generation (3G) broadband, packet-based transmission of text, digitized voice, and video. Various antennas are contemplated, such as SubMiniature version A (SMA) and micro coaxial connector (MCX).

“Transport Layer Security” (TLS) is security protocol from that is based on and supersedes Secure Sockets Layer 3.0. TLS uses digital certificates to authenticate the user as well as authenticate the network. The TLS client uses the public key from the server to encrypt a random number and send it back to the server. The public key, combined with additional random numbers previously sent to each other, is used to generate a secret session key to encrypt the subsequent message exchange.

“Firmware” is a specific class of computer software that provides low-level control for the device's specific hardware. Firmware can either provide a standardized operating environment for the device's more complex software or for less complex devices, act as the device's complete operating system, performing all control, monitoring and data manipulation functions. Typical examples of devices containing firmware are embedded systems, consumer appliances, computers, computer peripherals, and others. Almost all electronic devices beyond the simplest contain some firmware. Firmware is typically held in non-volatile memory such as read-only memory (ROM), electrically erasable read-only memory (EPROM), and flash memory.

A “Subscriber Identity Module” (SIM) card, is a smart card that stores data for cellular telephone users. Such data includes user identity, location and phone number, network authorization data, personal security keys, contact lists and stored text messages. Security features typically include authentication and encryption.

A “Universal Serial Bus” (USB) is a common interface that enables communication between devices and a host controller, typically a personal computer (PC) or tablet computer. It connects peripheral devices such as digital cameras, mice, keyboards, printers, scanners, media devices, external hard drives and flash drives.

“Media Access Control ID” (MAC ID) address is a unique identifier, typically 12 characters, used to identify a piece of hardware.

“Wi-Fi” is a family of radio wave technology used for the wireless local area networking (WLAN) of devices, generally based around the IEEE 802.11 family of standards.

“Bluetooth” is a wireless technology standard for exchanging data between devices over short distances using short-wavelength UHF radio waves in the industrial, scientific, and medical radio bands.

“Cellular phone”, “cell phone” or “mobile phone” are telephones that communicate using a cellular modem, typically, and thus do not need land lines. They include “smartphones”, which are cellular phones that also have general-purpose computers that support software applications (often called “apps” on smart phones) such as the Apple iPhone and “feature phones” or “flip phones” such as the Motorola RAZR.

“Bootloader” or “boot loader” is software that loads and starts the boot time tasks and processes of an operating system of a computer system or other system. It enables loading the operating system within the computer memory when a computer is started or booted up. A bootloader is also known as a boot manager or bootstrap loader.

“Flash memory” is a non-volatile memory chip or chips used for data that does not require power to store data. It has the ability to be electronically reprogrammed and erased. It is often found in USB flash drives, MP3 players, digital cameras and other devices.

Preferred Embodiments

The Security Device

The following is a preferred embodiment of the security device or device. While the device is herein often described as a security device, in many embodiments devices of the invention can be designed for and used in non-security applications. For example, a device can be used to detect motion from a waking baby or moving pet. Numerous applications, beyond those described below, both security and non-security related, are contemplated.

A preferred embodiment of the device is illustrated in FIG. 1 and FIG. 2. FIG. 1 is a top front view and FIG. 2 is a top rear view. Not all of the elements of the device are illustrated.

The device 101 is housed in a plastic case 103. The device has an infrared sensor 105, typically a passive infrared (PIR) sensor for detecting human or animal motion or incursion based on infrared light/heat. The device has a light sensor 107, typically a light dependent resistor (LDR) sensor 107 for detecting motion or opening of a space (and thus exposure to light). The light sensor is typically behind a clear window 109. The device typically will have a light emitting diode (LED) indicator 111 to indicate when one or more of the sensors is activated (and/or other status indication). The device may also have other LED sensor, for instance, to indicate when the cellular modem has been activated.

The device also will have one or more antennas 113 for the cellular modem. The antennas may be an on-board chip antenna or external dipole antenna, such as SMA or MCX. An external antenna may or may not protrude from the case of the device as shown in 113. The device typically will have a micro-USB port 115 or other means for charging the battery.

Initial Set Up and Pairing of the Device

In a preferred embodiment, the user receives a device by shipment or buys it at a retail store. The device typically comes with a battery that is inserted by a user and a SIM card as described below, already inserted into the device. The user may wish to fully charge the battery at this time.

Upon insertion of the battery, the device typically will automatically power up and then “arm”, or be in its detection state, after a few seconds. This detection state consumes very little power, and the state typically only will change upon event detection or user-initiated restart (by removing the battery) or firmware update (typically by engaging a recessed update button). This state can accurately be described as a sleeping state.

The device comes with instructions to download a smartphone app. The device has on it both a QR code and a numeric code as unique identifiers. Other unique identifiers are contemplated. If the user has a smartphone, he typically will download an app as instructed (for IoS, Android, Windows, or other) then scan the QR code with the camera so that the app receives the data and transmits it to the server architecture (generally cloud based) that supports the device. The servers receive the data that uniquely identifies the device and associate that particular device with the user's smartphone, either by designated account name, or phone number, or both.

Each device has a sticker that has a 2D barcode in the QR Code format. This QR code is a binary encoding of all the data necessary to identify and configure that specific device. Typically the QR code contains the IPv6 network address of the device encoded as an ASCII string. The advantage of a QR code over identifiers with less information is that QR codes can have additional meta data, such as the sales channel through which the device was purchased, the factory responsible for manufacturing the device, date of manufacture, information about other devices or software sold as part of a bundle, and amount of pre-paid service included with the device.

In a preferred embodiment, if the user should use a new or different smartphone, he would have to go through the entire setup and pairing process again. In other embodiments, the user establishes an account to associate with the device, and thus the pairing can be done in future from the account to the device as well, which obviates some of the above-described steps.

Initial set up and synching of the device without a smartphone (SMS)

In a preferred embodiment, the invention contemplates device management, including setup, with phones that are not smartphones, that is, cell phones that do not have general computing capabilities, but that typically support texting such as SMS. Such phones are often called flip phones or feature phones. Note that the presence of general computing capabilities (have a smartphone) does not preclude the following. Smartphones also typically have SMS capability and can be used in the same way. The invention also contemplates other messaging protocols.

The device has a numeric code or other unique identifier that the user texts, via the SMS text of other text capability on the phone, to a designated phone number. Thus that text application receives the data and transmits it to the server architecture, via a text phone and the Internet.

In a preferred embodiment, if the user should use a different smartphone, he would have to go through the setup and synch process again. In other embodiment, the user has an account that is associated with the device. These two embodiments are not mutually exclusive.

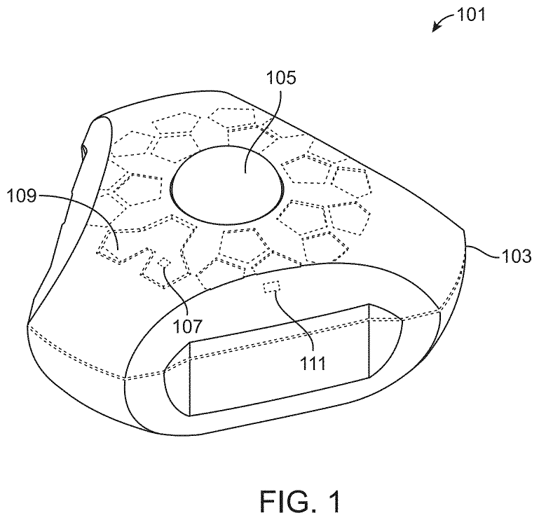

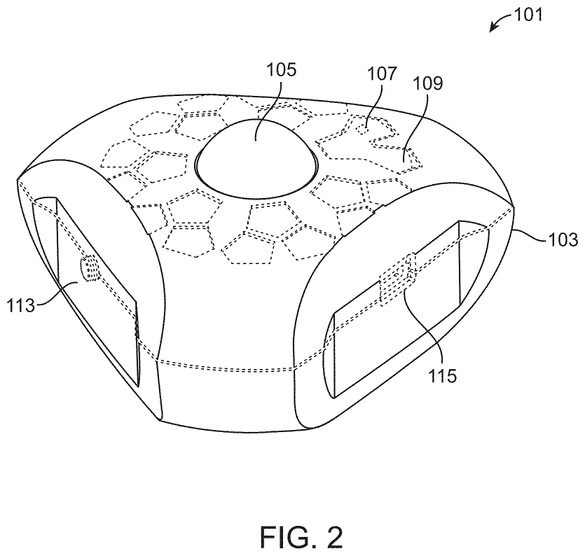

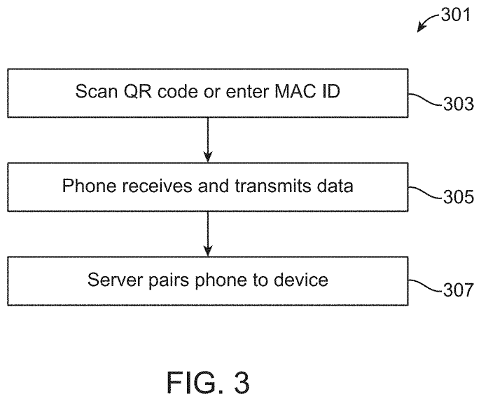

A summary overview of the method as shown in the flowchart of FIG. 3 301. The user scans the device QR code with his smartphone or enters a unique device identifier such as MAC ID 303. The phone receives the data and transmits it via smartphone app or messaging application to the server 305. Server looks up device information based on the received data and pairs phone (and optionally, user account) to the device 307.

Note that this set up process differs from the prior art in substantial ways, due to the unique systems and methods enclosed. Since the device is low power and not persistently connected to the Internet, it typically has no local connectivity capability, such as Bluetooth or Wi-Fi. Thus it cannot directly communicate with the smartphone of the user. So while the device is now, after setup, effectively paired to the user's account and smartphone, the synching was not done locally, but only mediated through the server architecture.

Note also that in order to accomplish this pairing, the server does not communicate with the device. The server already has the information on the unique device available, and thus can accomplish the pairing without communicating with the device. Thus the device is not disturbed from its low-power detection state. Within seconds of powering up, the device is in its armed, ready, low-power state. The user can place the device in its use context, typically a safe, closet, rental unit, storage space, or any other dark, undisturbed space that he wishes to secure. The device will remain in this detection state until an event occurs.

The invention's software backend (typically on a cloud based server service) receives inbound information, typically event alerts, from devices over GPRS and/or SMS, The server software sends out information to each user account and/or phone that corresponds to the associated unique device id, typically MAC ID. In a preferred embodiment the server software is programmed in Go. The invention utilizes a messaging API built on a platform using Twilio and Amazon Web Services Fargate.

The administration console for messaging and action protocols, including communication with clients, also can be implemented in various ways, including on Amazon Web Services lama and S3 instances. The databases are, in a preferred embodiment, PostgreSQL running on Amazon Web Services Relational Database Services.

The Device Hardware

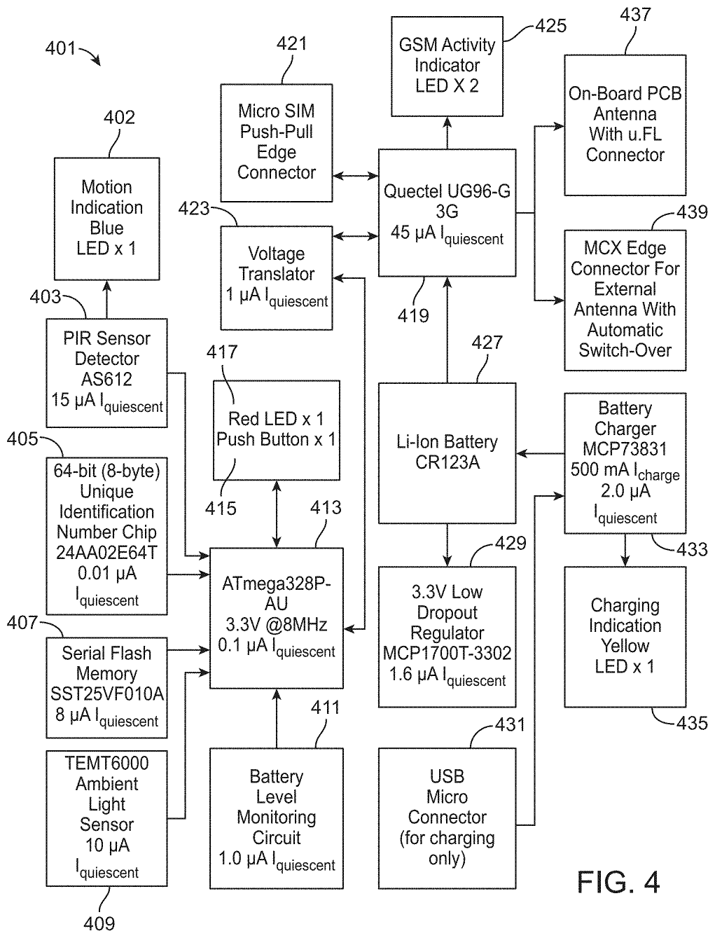

FIG. 4 is a hardware block diagram 401 of a related preferred embodiment of the device and invention. This embodiment of the device has one or more LED indicators 402 indicating when an infrared or light detection event has happened. The device also has a PIR sensor 403, MAC ID chip 405, serial flash memory 407, and a light sensor, 409. The device also has a battery level monitor 411, and a microprocessor 413, such as the ATmega328P-AU as shown. The ATmega328P-AU microprocessor is programmed in C++ and thus common developer environments such as the Arduino integrated development environment (IDE).

The device also has a recessed button for the user to press for a firmware update 415, and typically one or more LED indicators 417 indicating the firmware update process is happening. The device has a SIM card 419 such as the Quectel U96-G 3G Module for GSM transmission, as well as a SIM connector 421 which also aids in inserting and removing the SIM card, a voltage translator 423 for the SIM card, and one or more LEDs 425 for indicating SIM card/cellular modem card activity. The device has a battery 427 and a low dropout regulator 429, which is a step down voltage regulator for power management that needs very low voltage drop to operate. This allows the device to nearly the entire range of the Li-Ion battery charging while still keeping the low quiescent current needed for operation.

The device has a USB micro-controller port 431 for charging the battery with the battery charger 433, and or more LEDs 435 for indicating charging. Typically there is both an on-board printed circuit board (PCB) antenna 437 and an external antenna 439 such as the MCX connector shown.

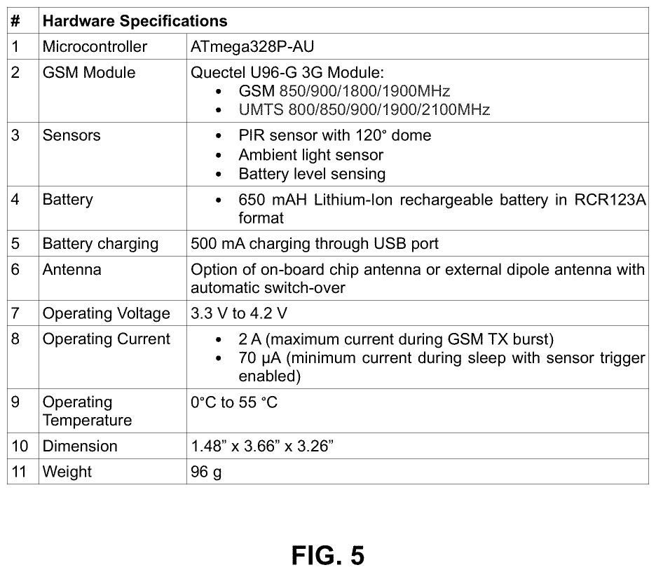

FIG. 5 is a table listing the hardware of the device and invention, compatible with the above preferred embodiment of FIG. 4. The arrows indicate information or energy flows in one or both directions between elements of the device hardware.

Event Detection & Firmware (FR) Update

An event is a change in the environment that the device is designed to detect. In a preferred environment it is any minor movement, heat, or light that the sensor is able to detect. Once an event occurs (one or more of the sensors on the device is triggered), the device will send out an alert to the server.

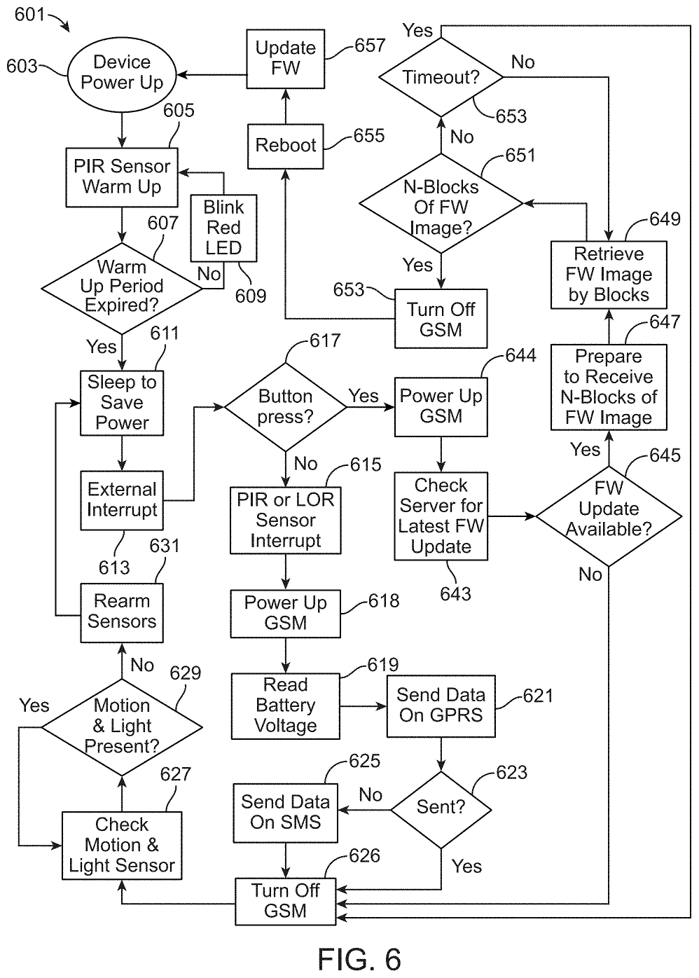

The flowchart 601 of FIG. 6 describes event detection, firmware update, and related steps. As is typical in the art, the process starts with a circle element, diamonds are branches or decisions, and rectangles are steps, process, or execution. The device is powered up 603, typically by inserting the battery. The PIR sensor then warms up 605, which takes just a few seconds 607. The LED will blink 609 during the warm-up. The device is then ready to operate, or armed, and is thus in its low power sleep mode 611. If the device is interrupted 613, it is either a sensor event 615 or a user button activation 617 as described above. When a sensor event occurs, the GSM SIM card powers up 618, the battery voltage is read 619, and data is sent by cellular modem 621, GSM preferably. Transmission is verified 623, and if there was a failure, the data is sent by SMS 625. The GSM SIM card is turned off 626. The sensors are then checked 627 and if they are still activated 629 they are rechecked 627 until they are no longer activated 629, in which case the sensors 631 are re-armed in their ready detection state and the device goes back to sleep 611.

If the interrupt was due to a user device button activation 617, then the SIM card is powered up 644 to check for a firmware (FW) update 643. If there is no update 645 the SIM card is powered down 626. If there is an update available 645 the device prepares to receive 647 and then retrieves 649 the image of the update in N-blocks. If the data is not all received and 651 there is no timeout 653 then the retrieval continues 649. If the data is all received 651 the SIM card is turned off 626, the device reboots 655 with the update 657 and the device powers up 603. If there is a timeout 653 before the data is received 651 then the SIM card is turned off 626.

The device can be “triggered” if either light, motion (an event), or a push button press is detected. The push button is used to update the device's firmware. In an event, where light or motion sensor is triggered or both, data will be sent to the server. Data will be sent using GPRS method at first, and if not possible (such as the network being unavailable), data will be sent using the SMS method. Once this data is sent to the server, the device will wait for the both light and motion to be absent before rearming. The device is still residing in the lowest power consumption mode even when in this un-armed state.

If the firmware update button is pressed instead of being triggered by the sensors, the device will perform an over the air (OTA) firmware update. This is carried out by querying the server on the availability of the latest firmware image. The device will compare the current revision of firmware residing on the device with the one available on the server. If the firmware image on the server is newer than it's current firmware, then an upgrade process will be carried out. Firmware image are being downloaded onto the device's external serial flash memory block by block. Checksum check is employed on the firmware image for data integrity. Once the entire firmware image is downloaded, the device will copy the newly downloaded firmware over to the main processor and the image on the external image will be erased immediately to prevent any act of copying the firmware image.

GPRS Based Alerts with SMS Fallback

In a preferred embodiment, the invention provides for the device to alert the server architecture of an event, preferably using GPRS, initially, and falling back to SMS if that fails.

In a preferred embodiment, the device first tries a connection via GPRS to lower associated costs and its ability to verify successful transmission. If verification is not received, the device will attempt to send the alert via an alternative such as SMS. Reasons for failure of either method generally would be due to poor cellular connectivity. The invention contemplates, and it is obvious to one of ordinary skill in the art, to use other communication protocols, both as initial options and as back up.

The invention contemplates that the user can register and pair his phone to receive alerts from a given device, de-register the phone from receiving alerts, designate and check which phones are synched to a given device. In a preferred embodiment of the invention, the device is a low power cellular based security sensor that does not need hubs, Wi-Fi, or external power. It is a unique security device sensor with about a year of battery life, global coverage and setup in seconds. The device is rechargeable with a standard micro-USB cable. In a preferred embodiment of the invention, the device battery life is about 1 year with regular use (10 alerts/month). The device will also indicate user when the battery is getting low either by alerting the server architecture or with an indicator on the device itself.

In general, poor cellular signal will not affect performance. As disclosed, the invention works with poor network signal environments, just like inside a thick metal safe. The device only sends a very small amount of data with each alert, and works great in poor network conditions. In a preferred embodiment of the invention, the device uses a special SIM card that connects to the best signal networks automatically, almost anywhere in the world. In a preferred embodiment of the invention, the device has full coverage in over 200 countries. In addition, the invention is designed for poor network environments.

In a preferred embodiment of the invention, the device is effectively an all-in-one security sensor that instantly makes any space safe. The device sends instant notifications and is portable, rechargeable, and cellular based. The device is a standalone sensor that doesn't need Wi-Fi, Bluetooth, a hub, or external power. The invention thus discloses systems, apparatus and method that are very secure, and difficult to hack and tamper. The device can be used to protect items such as guns in a gun safe, prescription drugs, hotel luggage, storage unit, cars, trailers, jewelry, as well as detect intrusion for its own sake.

Thus the invention can be used with (in addition) to a physical lock or physically-secured space. Note that Wi-Fi solutions are much more easily defeated than they current invention, in that they generally just need to be unplugged. Wi-Fi and Bluetooth are unreliable, have limited range, and are also easily defeated. The invention thus makes security, simple, well designed and reliable.

Data Packet Format

The alert data sent to the server either through GPRS or SMS are identical and typically is in a comma separated format terminated by a new line, in one embodiment the following data: MAC ID, BATTERY LEVEL IN VOLTS, GSM SIGNAL STRENGTH LEVEL (0-31), PHONE NUMBER (OPTIONAL), FIRMWARE REVISION (MAJOR.MINOR.PATCH), LATITUDE & LONGITUDE (done be cellular modem triangulation), SENSOR TRIGGER SOURCE (e.g., 1=LIGHT, 2=MOTION, 3=LIGHT & MOTION), GSM MODULE IMEI & SIM ICCID CELL ID, MOBILE COUNTRY CODE (MCC), MOBILE NETWORK CODE (MNC, LOCATION AREA CODE (LAC). Thus an example data packet could be as follows:

### 0004A30B0027B211,4.07V,19,+882360001653458,1.0.1,101.463257,3.09625 0,1,867688031954211,8944502311176213333F,54626A,310,410,DE78

Bootloader with Rescue Mode

The following in an embodiment for restoring rescue firmware for a device that might enter a non-functioning or “bricked” state due to a failed firmware update.

In the prior art, a typical method of doing firmware updates is to divide the memory into 3 partition sectors, the first sector for bootloader firmware, the second sector for the current active application firmware, and the third sector for an inactive copy of the application firmware. When a firmware update is required or requested, either the active application firmware or the bootloader firmware will download the new firmware (update) into the third sector. Then, when the device is in bootloader mode (when the bootloader firmware is running) the new firmware (update) is copied to the second sector. The device then exits bootloader mode and the new firmware update is run from the second sector.

In the current invention, the device memory (typically flash memory) is divided into four partition, also called sectors. The first sector holds the bootloader firmware, the second sector holds an active copy of the current application firmware, the third sector an identical, inactive copy of the current application firmware, and the fourth sector holds an inactive copy of a rescue firmware (also called default or safe firmware).

When a firmware update is required or requested, either the active application firmware or the bootloader firmware will download the new firmware (update) into the third sector. Then, when the device is in bootloader mode (when the bootloader firmware is running) the new firmware (update) is copied to the second sector. The device then exits bootloader mode and the new firmware update is run from the second sector, as in the prior art.

However, if a failure of such a firmware update occurs (whereby the may no longer continues to function, colloquially called “bricked”), the current invention can be rescued with the default or safe firmware in the fourth partition. A restart is initiated, for example, by the user pushing or holding down a designated restart button. The user can initiate this restart if he notices a problem with the device, or when directed to by instructions or by a notification from the app. Upon this restart, the bootloader firmware will copy the default/rescue/safe firmware from the fourth partition into the second partition. Then the bootloader firmware boots the second partition, and thus the device can function again. The firmware update process can then be initiated to try the firmware update again. While in a preferred embodiment the device does not have local connectivity in an embodiment, a restart can be initiated by a wireless command such as a Bluetooth or Wi-Fi signal, or other means such as a switch, knob, or resistive or capacitive sensor

Thus the invention avoids a common problem in the prior art, where it may be necessary for the user to send the device back to the supplier or use special tools for reprogramming to restore the application firmware. The invention provides a way for the user to restore the devices application firmware easily.

Thus the invention includes apparatus, systems, and methods for restoring the default mode, or rescue, of firmware for a device that has entered a non-functioning or sub-optimal state (colloquially called “bricked”) during, for instance, a failed firmware update. This could happen for example if firmware on the device has been corrupted, the flash process fails, or some other type of firmware update.

In a preferred embodiment, a mechanism for such rescue includes the dividing the device flash memory (or other type of memory) into at least three partitions. In a preferred embodiment, the first partition consists of the standard, active application firmware, the second partition consists of inactive application firmware which is updated and written when receiving a new firmware update, and the third partition consists of the default/rescue firmware.

In a preferred embodiment, in the typical firmware update sequence, once the second partition has been updated with the new firmware, a restart of the device is signaled, and the bootloader copies the inactive firmware partition into the active firmware partition, thus updating the device firmware to the new/updated version. With failure of such firmware update whereby the device no longer continues to function properly, one method of rescue involves starts with the user holding down a button while restarting the device, which signals the bootloader to copy the default/rescue firmware from the third partition into the active firmware partition, thus restoring the device to an operational state of operation. There are of course many other ways in which this rescue can be initiated, which are obvious to one of ordinary skill in the art.

General Packet Radio Service (GPRS) Based Firmware Updates

The following is a preferred embodiment for downloading firmware updates to a device. This can be initiated, for example, by a user putting the device into update mode by pressing a button, a server initiated update, mobile device initiated update, etc.

In a preferred embodiment, the invention uses a low-power GSM based GPRS 2G/3G standard to download firmware updates to the device from a cloud server. While this process is described above, including FIG. 6, it is here described again with other details. The method establishes a secure connection, such as via TLS, between the device and server. The device sends and the server receives data on the current firmware version and hardware ID. The server sends the device at least the firmware version available for download, the size of the download, and a checksum of the download for the device to verify download integrity. The device, optionally, requests from the server certain components of the update file by specifying starting index and ending index, repeating as necessary. The device terminates the connection upon successful firmware download.

Computer Apparatus, Systems, and Methods

Various elements of the invention are described as modules implemented as software on a general-purpose computer and others as hardware elements. It should be apparent that in various embodiments of the invention, implementation of software can be executed by embedded hardware, or vice versa, or in some combination of software and hardware. Also, a computer may take the form of an integrated circuit, printed circuit board, handheld computer, or any general-purpose computer without limitation.

Part of the invention may be implemented by a general-purpose computer, embedded circuitry, or some combination of these. The software execution may be accomplished through the use of a program storage device readable by the computer and encoding a program of instructions executable by the computer for performing the operations described above. The program storage device may take the form of any memory known in the art or subsequently developed. The program of instructions may be object code, e.g., in binary form that is executable more-or-less directly by the computer; in source code that requires compilation or interpretation before execution; or in some intermediate form such as partially compiled code and/or a collection of executable library files. The precise forms of the program storage device and of the encoding of instructions are immaterial here.

The invention also contemplates use of computer networks known in the art, including but not limited to, intranets such as corporate networks, local and wide area networks, the Internet and the World Wide Web. Wire and wireless communication and communication protocols known in the art, such as, but not limited to, radio, infrared, Bluetooth, Ethernet and other wireless and wired networks, are also contemplated.

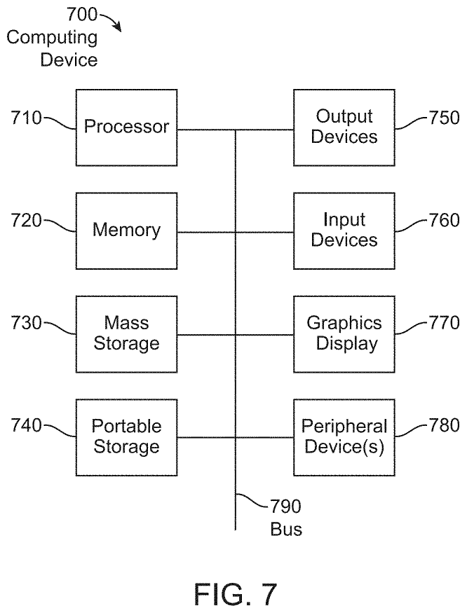

FIG. 7 is a block diagram of an exemplary computing system that may be utilized to practice aspects of the present disclosure. FIG. 7 illustrates an exemplary computing device 700 that may be used to implement an embodiment of the present systems and methods. The system 700 of FIG. 7 may be implemented in the contexts of the likes of computing devices, networks, servers, or combinations thereof. The computing device 700 of FIG. 7 includes one or more processors 710 and main memory 720. Main memory 720 stores, in part, instructions and data for execution by processor 710. Main memory 720 may store the executable code when in operation. The system 700 of FIG. 7 further includes a mass storage device 730, portable storage device 740, output devices 750, user input devices 760, a display system 770, and peripheral devices 780. In some embodiments, main memory 720 is used by storage for storing data.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and output devices 750 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 may store the system software for implementing embodiments of the present technology for purposes of loading that software into main memory 720. In some embodiments, portable storage device 740 is used by storage for storing data.

Portable storage device 740 operates in conjunction with a portable non-volatile storage medium, such as a floppy disk, compact disk, digital video disc, or USB storage device, to input and output data and code to and from the computer system 700 of FIG. 7. The system software for implementing embodiments of the present technology may be stored on such a portable medium and input to the computer system 700 via the portable storage device 840. In some embodiments, portable storage device 740 is used by storage for storing data.

User input devices 760 provide a portion of a user interface. User input devices 760 may include an alphanumeric keypad, such as a keyboard, for inputting alpha-numeric and other information, or a pointing device, such as a mouse, a trackball, stylus, or cursor direction keys. Additional user input devices 760 may be comprised of, but are not limited to, devices such as speech recognition systems, facial recognition systems, motion-based input systems, gesture-based systems, and so forth. For example, user input devices 860 may include a touchscreen. Additionally, the system 700 as shown in FIG. 7 includes output devices 750. Suitable output devices include speakers, printers, network interfaces, and monitors.

Output devices 750 may include a liquid crystal display (LCD) or other suitable display device. Display system 750 receives textual and graphical information, and processes the information for output to the display device.

Peripheral device(s) 780 may include any type of computer support device to add additional functionality to the computer system. Peripheral device(s) 780 may include a modem or a router.

The components provided in the computer system 700 of FIG. 7 are those typically found in computer systems that may be suitable for use with embodiments of the present technology and are intended to represent a broad category of such computer components that are well known in the art. Thus, the computer system 700 of FIG. 7 may be a personal computer, hand held computing device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows, Mac OS, Palm OS, Android, iOS, QNX, and other suitable operating systems.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present technology may be written in any combination of one or more programming languages, including an object oriented programming language such as Python, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be coupled with the user's computer through any type of network, including a local area network (LAN) or a wide area network (WAN), or the connection may be made to an external computer (for example, through the Internet using an Internet Service Provider).

With regard to the present invention, the many features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

Various elements of the invention are described as modules implemented as software on a general purpose computer and others as hardware elements. It should be apparent that in various embodiments of the invention, implementation of software can be executed by embedded hardware, or vice versa, or in some combination of software and hardware. Also, a computer may take the form of an integrated circuit, printed circuit board, handheld computer, or any general-purpose computer without limitation.

Part of the invention may be implemented by a general-purpose computer, embedded circuitry, or some combination of these. The software execution may be accomplished through the use of a program storage device readable by the computer and encoding a program of instructions executable by the computer for performing the operations described above. The program storage device may take the form of any memory known in the art or subsequently developed. The program of instructions may be object code, i.e., in binary form that is executable more-or-less directly by the computer; in source code that requires compilation or interpretation before execution; or in some intermediate form such as partially compiled code and/or a collection of executable library files. The precise forms of the program storage device and of the encoding of instructions are immaterial here.

The invention also contemplates use of computer networks known in the art, including but not limited to, intranets such as corporate networks, local and wide area networks, the Internet and the World Wide Web. Wire and wireless communication and communication protocols known in the art, such as, but not limited to, radio, infrared, Bluetooth, Ethernet and other wireless and wired networks, are also contemplated.

With regard to the present invention, the many features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

Preferred embodiments of flow direction between elements, looping and iteration are discussed, but alternative embodiments of these flows are contemplated by the invention. Any elements or other features described in the figures, even if not described in the specification, are supported in the figures so as to be enabling. All references cited here are incorporated in their entirety for all purposes.

What is claimed is:

1. A method for pairing a device with a smartphone via a server, the method comprising:
(a) receiving data relating to a unique identifier scanned by a user using the smartphone; and
(b) using the data to pair the smartphone to the device via the server;
wherein the method does not require either the smartphone or the server to communicate with the device.

2. The method of claim 1 wherein the first unique identifier is a QR code that identifies the device.

3. The method of claim 1 wherein the second unique identifier is a MAC ID address that identifies the device.

4. The method of claim 1 wherein the device has no local connection capability, including Bluetooth and Wi-Fi.

5. The method of claim 1 wherein the server is a cloud server.

6. The method of claim 1 wherein the data is received by an app on the smartphone and received by the server from the app via the Internet.

7. The method of claim 1 wherein the device has a cellular modem for connecting to the Internet.

8. The method of claim 1 wherein the device has means for identifying an event.

9. The method of claim 1 wherein the device has one or more of the following: a motion detector, electromagnetic radiation detector, sound detector.

10. A method for pairing a device with a cell phone via a server, the method comprising:
(a) receiving data relating to a unique identifier manually entered by a user using the cell phone; and
(b) using the data to pair the smartphone to the device via a server;
wherein the method does not require either the smartphone or the server to communicate with the device.

11. The method of claim 10 wherein the cell phone is a smartphone.

12. The method of claim 10 wherein the cell phone is a not a smartphone.

13. The method of claim 10 wherein the unique identifier is a MAC address that identifies the device.

14. The method of claim 10 wherein the device has no local connection capability, including Bluetooth and Wi-Fi.

15. The method of claim 10 wherein the server is a cloud server.

16. The method of claim 10 wherein the data is received by a text message application on the cell phone and received by the server from the text message application via a cell phone network and the Internet.

17. The method of claim 10 wherein the device has a cellular modem for connecting to the Internet.

18. The method of claim 10 wherein the device has means for identifying an event.

19. The method of claim 10 wherein the device has one or more of the following: a motion detector, electromagnetic radiation detector, sound detector.

20. A method of rescuing a device firmware, wherein the device has memory comprising four partitions, a first partition which has a boot loader firmware, a second partition which has an application firmware, a third partition which has a second copy of the application firmware, and a fourth partition which has a rescue firmware, the method comprising:
(a) upon restart of the device, downloading a firmware update into second partition;
(b) running the firmware update; and
(c) in an event of failure of the firmware update, running the rescue firmware.
